(19) United States
(12) Patent Application Publication
(10) Pub. No.: US 2024/0248592 A1
(43) Pub. Date: Jul. 25, 2024

(54) USER INTERFACE MODIFICATION FOR MEDICAL DEVICE

(71) Applicant: Hill-Rom Services, Inc., Batesville, IN (US)

(72) Inventors: Robert Mark Zerhusen, Cincinnati, OH (US); Gavin Monson, Oxford, OH (US)

(21) Appl. No.: 18/403,984

(22) Filed: Jan. 4, 2024

Related U.S. Application Data
(60) Provisional application No. 63/481,221, filed on Jan. 24, 2023.

(51) Int. Cl. G06F 3/04845; G06F 3/0481

(52) U.S. Cl. CPC G06F 3/04845; G06F 3/0481

(57) ABSTRACT

A system for operating a medical device monitors an environment of the medical device. The system detects a change in the environment including at least one of a change in a location of the medical device and a presence of a user near the medical device. The system modifies a user interface displayed on the medical device in response to the change in the environment, the user interface being modified based on the location of the medical device, a role of the user, and a disability of the user.

### BACKGROUND

Healthcare environments such as hospitals track a variety of different assets. For instance, the locations of medical devices such as hospital beds, infusion pumps, and respirators may be relevant to providing and maintaining a high level of healthcare in these environments. Also, the locations of caregivers such as registered nurses, physician assistants, and respiratory therapists can be relevant for efficiently delivering healthcare in these environments.

### SUMMARY

The present disclosure generally relates to providing optimized user interfaces on medical devices based on their location and/or the proximity of one or more users. Various aspects are described, which include, but are not limited to, the following aspects.

One aspect relates to a system for operating a medical device, the system comprising: at least one processing device; and a memory device storing instructions which, when executed by the at least one processing device, cause the at least one processing device to: monitor an environment of the medical device; detect a change in the environment including at least one of a change in a location of the medical device and a presence of a user near the medical device; and modify a user interface displayed on the medical device in response to the change in the environment, the user interface being modified based on the location of the medical device, a role of the user, and a disability of the user.

Another aspect relates to a method of operating a medical device, the method comprising: monitoring an environment of the medical device; detecting a change in the environment including at least one of a change in a location of the medical device and a presence of a user near the medical device; and modifying a user interface displayed on the medical device in response to the change in the environment, the user interface being modified based on the location of the medical device, a role of the user, and a disability of the user.

Another aspect relates to a non-transitory computer-readable data storage medium comprising instructions that, when executed, cause at least one computing device to: monitor an environment of the medical device; detect a change in the environment including at least one of a change in a location of the medical device and a presence of a user near the medical device; and modify a user interface displayed on the medical device in response to the change in the environment, the user interface being modified based on the location of the medical device, a role of the user, and a disability of the user.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawing figures, which form a part of this application, are illustrative of the described technology and are not meant to limit the scope of the disclosure in any manner.

FIG. 1 is an isometric view of an example of a medical device equipped with user interface optimization in accordance with the concepts described in the present disclosure.

FIG. 2 is another isometric view of the medical device of FIG. 1.

FIG. 3 is a detailed view of a display device of the medical device of FIG. 1, the display device being shown in a stowed position.

FIG. 4 is another detailed view of a display device of the medical device of FIG. 1, the display device being shown in a deployed position.

FIG. 5 schematically illustrates an example of a method of providing an optimized user interface on the medical device of FIG. 1.

FIG. 6 shows the medical device of FIG. 1 positioned in a first location and displaying a user interface associated with the first location.

FIG. 7 illustrates in more detail the user interface of FIG. 7.

FIG. 8 shows the medical device of FIG. 1 positioned in a second location and displaying a user interface associated with the second location.

FIG. 9 illustrates in more detail the user interface of FIG. 8.

FIG. 10 illustrates an example of a caregiver near the medical device of FIG. 1.

FIG. 11 illustrates an example of modifying the user interface displayed on the medical device of FIG. 1 based on a role of the caregiver.

FIG. 12 illustrates another example of modifying the user interface displayed on the medical device based on both a role and a disability of the user.

FIG. 13 illustrates in more detail the user interface of FIG. 12.

FIG. 14 illustrates an example of a general access screen optimized for registered nurses that can be displayed on the medical device of FIG. 1.

FIG. 15 illustrates another example of a general access screen optimized for registered nurses that can be displayed on the medical device of FIG. 1.

FIG. 16 shows an example of a user interface optimized for use by personal care assistants and certified nurse aides that can be displayed on the medical device of FIG. 1.

FIG. 17 illustrates an exemplary architecture of a computing device that can be used by the medical device of FIG. 1 to implement aspects of the present disclosure.

### DETAILED DESCRIPTION

Various embodiments will be described in detail with reference to the drawings, where like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

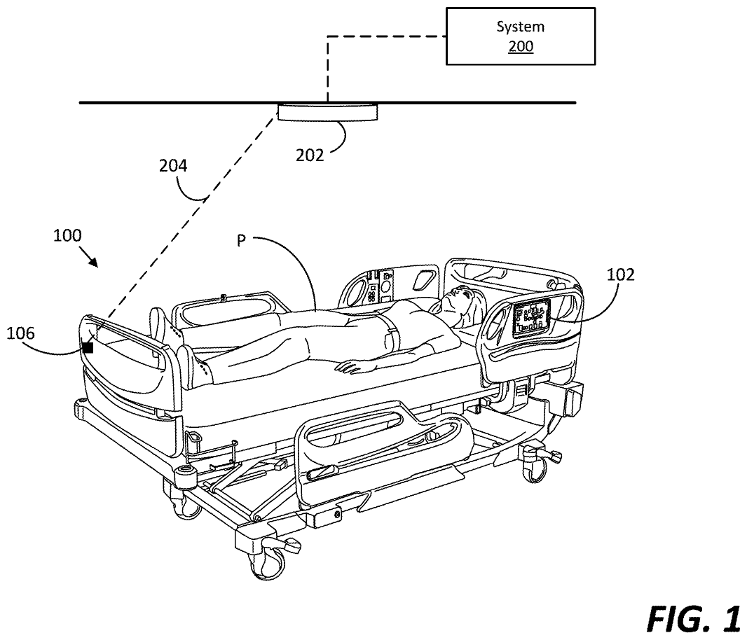

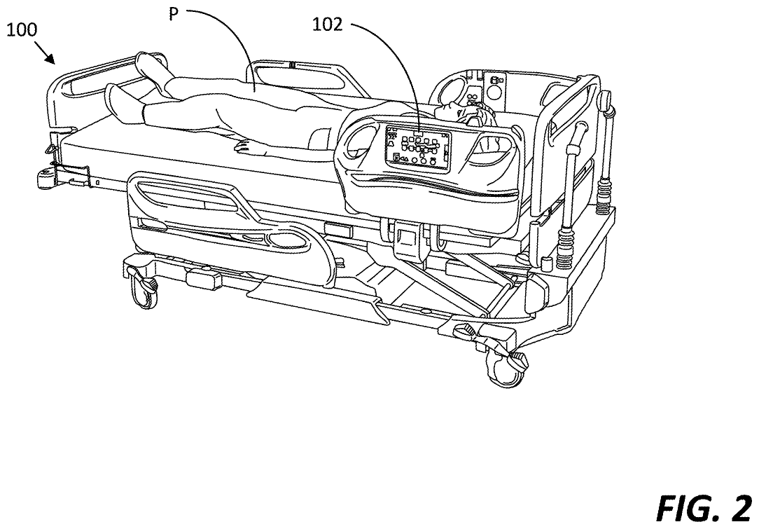

FIGS. 1 and 2 are isometric views of an example of a medical device 100 having a display device 102 that displays user interfaces that are optimized based on the environment surrounding the medical device 100. In this example, the medical device 100 is depicted as a patient support apparatus such as a hospital bed on which a patient P is resting in a supine position. The user interface optimization concepts described herein are applicable to additional types of patient support apparatuses including, for example, other types of beds, patient tables, stretchers, wheelchairs, and the like. Similarly, these concepts are applicable to additional types of medical devices including, for example, infusion pumps, respirators, and the like.

The display device 102 displays user interfaces for a user to control operation of the medical device 100. Users of the medical device 100 can include trained medical professionals such as physicians, registered nurses, physician assistants, respiratory therapists, personal care assistants, certified nurse aides, and the like. Additionally, users of the medical device 100 can include persons who are not trained medical professionals such as visitors of the patient P including family members and friends, as well as the patient P herself/himself.

In some examples, the display device 102 includes a touchscreen that acts as an input device such as for displaying controls for selection by a user of the medical device 100 and receiving selections of the controls and other inputs from the user. Additionally, the display device 102 can act as an output device such as for displaying data and information related to the patient P. As will be described in more detail, the display device 102 displays user interfaces that are optimized based on the environment of the medical device 100 such as its location within a healthcare facility and/or the proximity of users to the medical device 100.

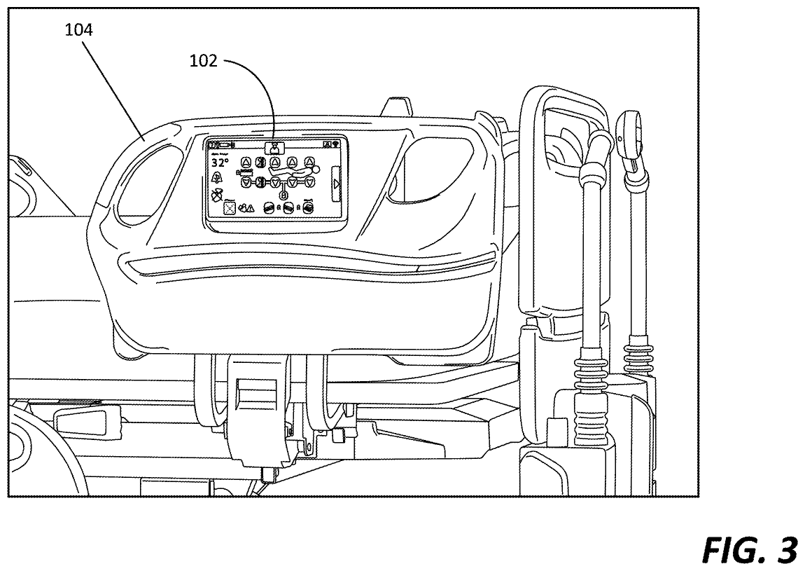

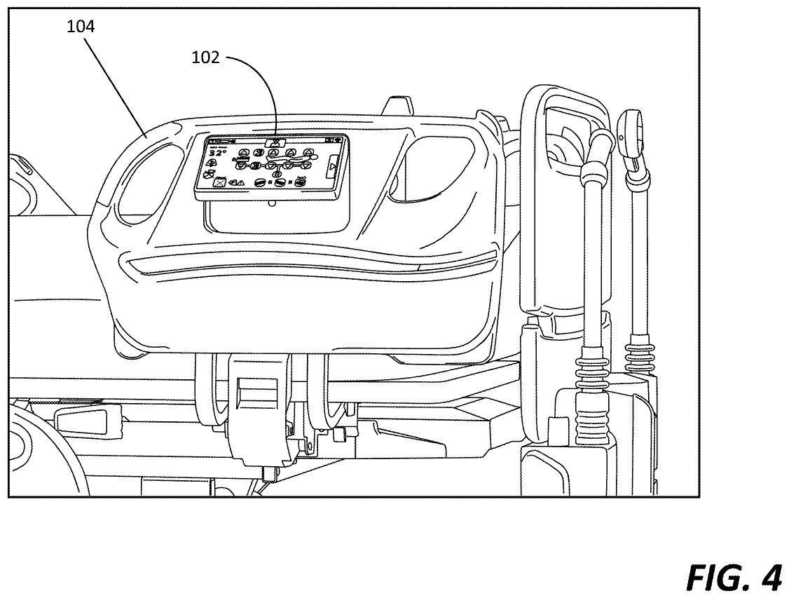

FIGS. 3 and 4 are detailed views of the display device 102. Referring now to FIGS. 1-4, the display device 102 is depicted as being positioned on a siderail 104 of the hospital bed. However, the position of the display device 102 may vary such that it can be positioned on a footboard, headboard, or elsewhere on the medical device. Also, in examples where the medical device 100 is another type of device such as an infusion pump, respirator, and the like, the display device 102 can be positioned elsewhere on the medical device.

In FIG. 3, the display device 102 is shown in a stowed position such that the display device 102 is substantially flush with the siderail 104. In FIG. 4, the display device 102 is shown in a deployed position such that the display device 102 is pivoted (e.g., flipped upward) with respect to the siderail 104. When in the deployed position, the visibility and accessibility of the display device 102 is improved for a user of the medical device 100.

Referring to FIG. 1, the medical device 100 further includes a tag 106. As will be described in more detail below, the tag 106 can communicate with a receiver 202 of a system 200 to identify the location of the medical device 100 within the healthcare facility. The tag 106 can be attached or embedded anywhere on the medical device 100. The tag 106 wirelessly communicates signals 204 to the receivers 202 that distributed throughout a healthcare facility.

In some examples, the tag 106 is a passive tag powered by energy emitted from the receiver 202. Alternatively, the tag 106 can be an active tag that is powered by a power source on the medical device 100. The tag 106 wirelessly communicates the signal 204 via radiofrequency, Bluetooth®, infrared (IR), Wi-Fi, or the like. In some examples, the tag 106 is a Radio-Frequency Identification (RFID) tag. However, the concepts described herein are not limited to RFID tags such that other types of tags that use non-radio-frequency electromagnetic signals such as acoustic signals or the like can be attached or embedded on the medical device 100.

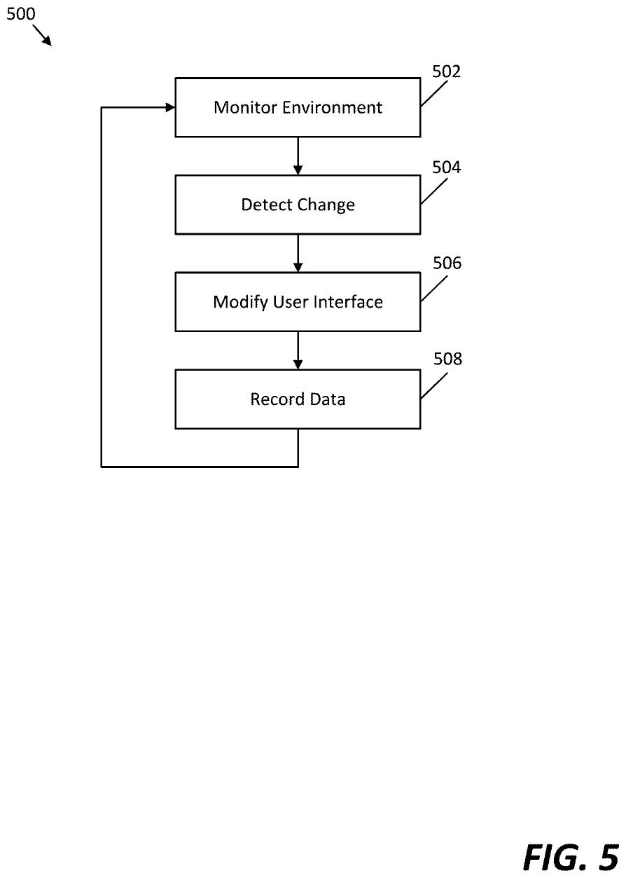

FIG. 5 schematically illustrates an example of a method 500 of generating an optimized user interface on the medical device 100. In accordance with the examples described above, the user interface can be displayed on the display device 102 for a user to control the operation of the medical device 100.

The method 500 includes an operation 502 of monitoring an environment of the medical device 100. The environment of the medical device 100 can include the location of the medical device 100 and the personnel around the medical device 100. The location of the medical device 100 can include whether the medical device is located in a room, unit, department, or floor of the healthcare facility. The personnel around the medical device 100 includes users who are near the medical device 100 such as the patient P, visitors of the patient P (e.g., family members and friends), and medical professionals such as doctors, registered nurses, physician assistants, respiratory therapists, personal care assistants, and the like.

Next, the method 500 includes an operation 504 of detecting a change in the environment of the medical device 100, followed by an operation 506 of modifying the user interface displayed on the display device 102 based on the change detected in operation 504.

In some examples, operation 506 includes communicating with other medical devices around the medical device 100 to enable or disable control functions on those devices based on the change detected in operation 504. As an illustrative example, when the medical device 100 is a hospital bed, the system 200 communicates with infusion pumps, monitoring devices, and other medical devices typically found in a care environment surrounding the hospital bed to enable or disable control functions on those devices based on the change detected in operation 504.

In some further examples, the method 500 can include an operation 508 of recording data on the changes in the environment of the medical device 100 detected in operation 504 and/or inputs received from the user interface modified in operation 506. For example, operation 508 can include recording a time and a location of an input received from the user interface modified in operation 506. Operation 508 can further include recording an identity of a user who entered the input received from the user interface modified in operation 506 such as by recording an ID number included in a signal transmitted by a tag worn by the user, which will be explained in more detail below. Operation 508 allows a log to be maintained of the inputs received via the various user interfaces that are generated and displayed on the medical device 100. Subsequently, an operator can review the log to identify errors and make improvements to the user interfaces based on their use in the healthcare facility over a period of time.

After completion of operation 508, the method 500 can return to operation 502 to continuously monitor the environment of the medical device 100 (operation 502), detect changes in the environment of the medical device 100 (operation 504), modify the user interface displayed on the display device 102 based on the detected changes (operation 506), and record data on the changes in the environment and the inputs received (operation 508).

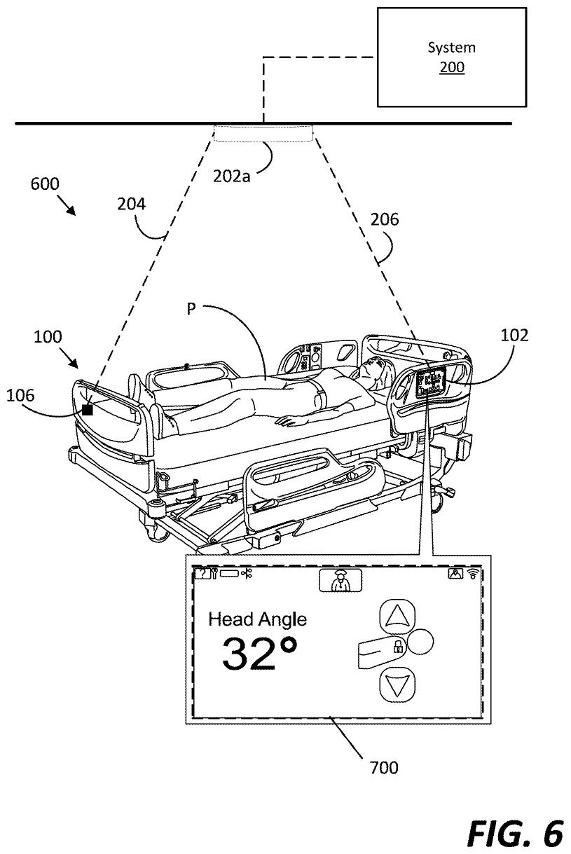

FIGS. 6-9 illustrate a first example in which operation 504 includes detecting a change in a location of the medical device 100, and operation 506 includes modifying the user interface displayed on the display device 102 based on the detected change in the location of the medical device 100. FIG. 6 shows the medical device 100 positioned in a first location 600. As an example, the first location 600 can be a triage area of the healthcare facility.

A receiver 202a is fixed in the first location 600 and receives the signal 204 from the tag 106 on the medical device 100. In this example, the receiver 202a is fixed to a ceiling in the first location 600 such that the receiver 202a is fixed above the medical device 100. The location where the receiver 202a is fixed in the first location 600 may vary such that the receiver 202a can be fixed to a wall, a floor, an object associated with the first location 600, or elsewhere.

The signal 204 that the tag 106 communicates to the receiver 202a includes digital data such as an identification (ID) number that can be used by the system 200 to identify the medical device 100. The ID number along with the first location 600 where the receiver 202a is fixed can be used by the system 200 to determine that the medical device 100 is in the first location 600. In some example embodiments, the location of the medical device 100 can be determined using one or more of the techniques described in U.S. Pat. No. 11,363,419, titled Intelligent Location Estimation for Assets in Clinical Environments, issued Jun. 14, 2022, the disclosure of which is herein incorporated by reference in its entirety.

As further shown in FIG. 6, the system 200 can use the receiver 202a to transmit a signal 206 to the medical device 100. The signal 206 causes the display device 102 to display a user interface 700. The user interface 700 is associated with the first location 600.

In alternative examples, the medical device 100 can be equipped with a Global Positioning System (GPS) device or similar type of device such that the medical device 100 can determine its location in the medical facility without having to rely on the system 200 and the receiver 202a. In such examples, the medical device 100 can automatically display the user interface 700 once the medical device 100 determines that it is in the first location 600.

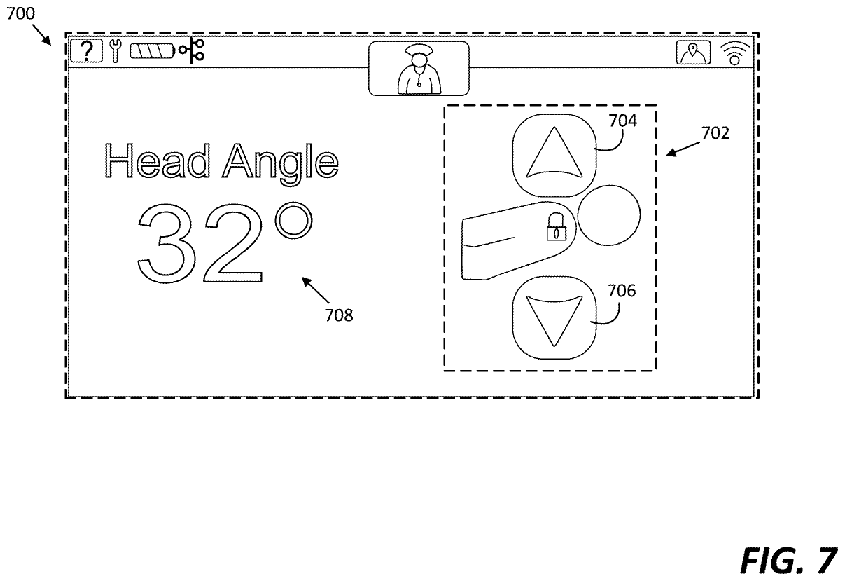

FIG. 7 illustrates in more detail the user interface 700 that can be displayed on the display device 102 when the medical device is detected as being in the first location 600. The user interface 700 is optimized for visitors of the patient P (e.g., family members and friends) and other nonmedical personnel. For example, the user interface 700 has a minimum functionality displayed. As will be described in more detail, the nonmedical personnel such as the visitors of the patient P can wear personnel tracking devices such as wireless tags, which allows the system 200 to detect their presence near the medical device 100.

The user interface 700 includes a first set of controls 702 selectively displayed based on the expected procedures and/or treatments typically performed in the first location 600. In this example, the first set of control 702 include an upward arrow 704 that can be selected by a user to raise the head section angle 708 of the hospital bed and a downward arrow 706 that can be selected by the user to lower the head section angle 708 of the hospital bed. In some examples, the upward arrow 704 and the downward arrow 706 can be selected by the user to adjust the head section angle 708 of the hospital bed to range from 0 degrees to 65 degrees.

As shown in FIG. 7, the first set of controls 702 are simplified such that more complex or sophisticated controls are not displayed for selection on the display device 102. This can simplify the user interface displayed on the medical device 100, which is advantageous for the users in the first location 600 who do not need to use more complex or sophisticated controls. Thus, the system 200 automatically modifies the user interface 700 displayed on the medical device 100 such that the user interface is optimized for use in the first location 600.

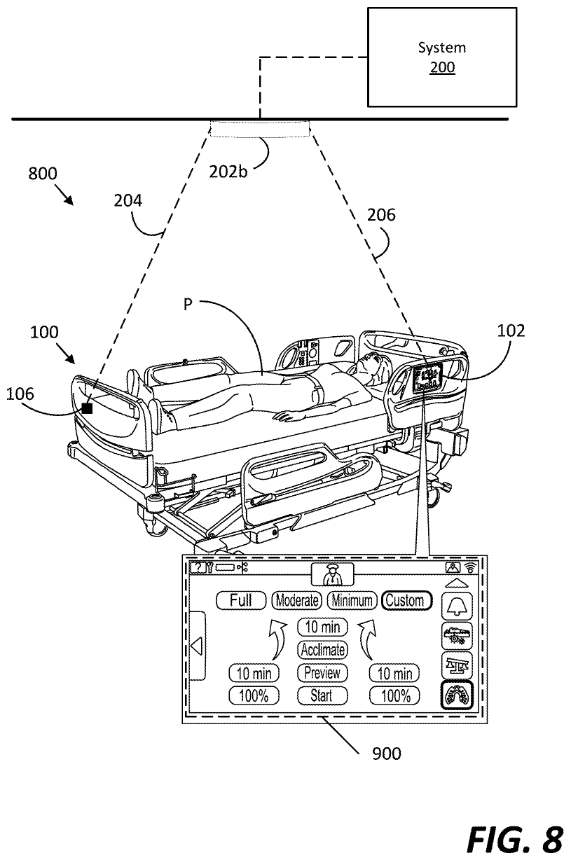

FIG. 8 shows the medical device 100 positioned in a second location 800. Like in the example shown in FIG. 6, a receiver 202b is fixed in the second location 800 and receives the signal 204 from the tag 106 on the medical device 100. Like in the first location 600, where the receiver 202b is fixed in the second location 800 may vary such that the receiver 202b can be fixed to a ceiling, a wall, a floor, an object associated with the second location 800, or the like. In this example, the second location 800 is a respiratory acute care unit within the healthcare facility. In some further examples, the second location 800 is a step-down unit for COVID-19.

The signal 204 that the tag 106 transmits to the receiver 202b includes the ID number of the medical device 100 such that the system 200 can determine that the medical device 100 is in the second location 800. In response, the system 200 can use the receiver 202b to transmit a signal 206 to the medical device 100 that causes the display device 102 to display a user interface 900. The user interface 900 is associated with the second location 800.

In examples in which the medical device 100 is equipped with a GPS device or similar type of device, the medical device 100 can determine it is in the second location 800 without having to rely on the system 200 and the receiver 202b. In such examples, the medical device 100 can automatically display the user interface 900 once the medical device 100 determines that it is in the second location 800.

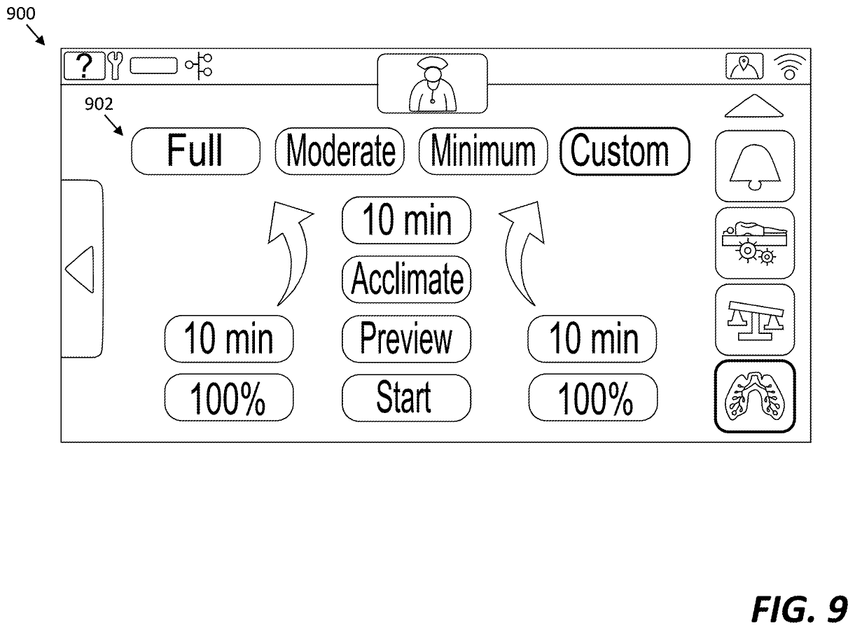

FIG. 9 illustrates in more detail the user interface 900 that can be displayed on the display device 102 when the medical device 100 is detected as being in the second location 800. The user interface 900 includes a second set of controls 902 that are optimized for use in the second location 800. For example, the second set of controls 902 include controls for continuous lateral rotation therapy (CLRT) to mechanically rotate a patient continuously in bed for treatment of pulmonary diseases (e.g., pneumonia, COVID-19, etc.) by mobilizing secretions in the lungs. CLRT is typically performed in a respiratory acute care unit (e.g., the second location 800) and not in a triage area (e.g., the first location 600) of a healthcare facility.

In some examples, the user interface 900 provides access to other controls if needed such as the first set of controls 702 for adjusting the head section angle 708 of the hospital bed. Alternatively, the user interface 900 is locked to only display the second set of controls 902 such that a user is blocked from viewing and/or selecting other controls such as the first set of controls 702 while the medical device 100 remains in the second location 800. Advantageously, the system 200 automatically modifies the user interface displayed on the medical device 100 to be optimal for use in the location where the medical device 100 is physically located.

Referring to FIG. 5, in another illustrative example, operation 504 includes detecting a change in the environment of the medical device 100 by detecting a presence of a user near the medical device 100, and operation 506 includes modifying the user interface displayed on the display device 102 based on the user who is detected to be in proximity to the medical device 100. This example will now be explained in more detail.

As shown in FIG. 6, the user interface 700 displayed on the medical device 100 includes simplified controls. In some examples, the user interface 700 is considered a safe user interface such that the user interface 700 can be used by visitors of the patient P such as family members and friends to improve the patient P's comfort while the patient P rests on the medical device 100. For example, a family member or friend of the patient P can use the user interface 700 to adjust up and down the head section angle of the bed. The user interface 700 can block a user from viewing and/or selecting more complex or sophisticated controls that can potentially cause injury or harm to the patient P without the presence of a trained medical professional. Also, the user interface 700 can block a user from adjusting certain operational parameters of the medical device 100 such as alarm settings including exit alarms, and treatment protocols.

As will now be described in more detail, when a caregiver moves in proximity to the medical device 100, software prioritization causes the display device 102 to stop displaying the user interface 700, and to instead display a new user interface for use by the caregiver. For example, the new user interface displayed on the medical device 100 can include enhanced controls such as to allow adjusting certain operational parameters of the medical device 100 such as alarm settings which are blocked without the presence of the caregiver.

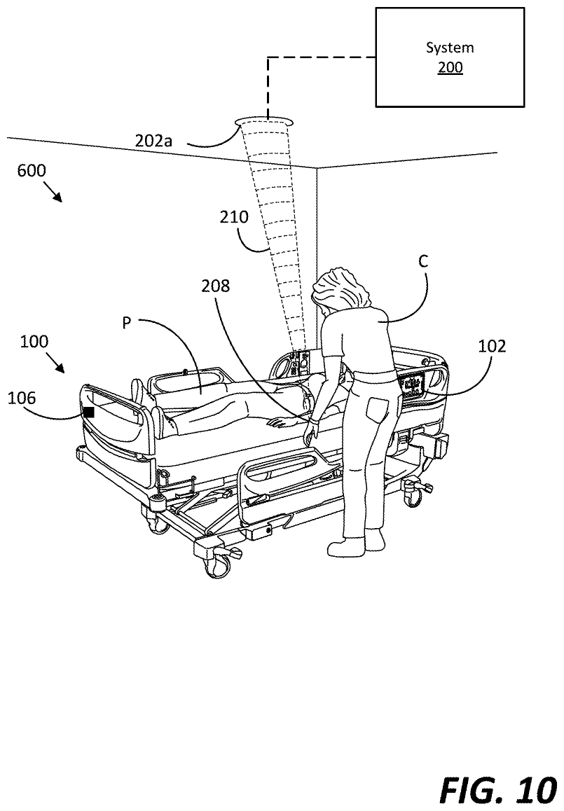

FIG. 10 illustrates an example of a caregiver near the medical device 100. As will be explained in more detail, FIG. 10 shows how a receiver detects a signal from a personnel tracking device, and through hospital Ethernet, the system 200 alters the user interface on the medical device 100. Alternatively, the medical device 100 can detect the signal from the personnel tracking device directly for altering the user interface displayed on the medical device.

In this example, the caregiver C is in the first location 600 (see also FIG. 6) which is where the medical device 100 is located. In this example, the caregiver C is a trained medical professional such as a respiratory therapist. The caregiver C is wearing a tag 208 that wirelessly transmits a signal 210 to the receiver 202a. The tag 208 is similar to the tag 106 described above.

In the example of FIG. 10, the tag 208 is depicted as being attached to or embedded in a bracelet worn around the wrist of the caregiver C. In other examples, the tag 208 can be attached to or embedded in other types of accessories worn by the caregiver C such as a lanyard worn around the neck of the caregiver C, or an item such as a card held inside a pocket of clothing worn by the caregiver C. In yet further examples, a device used by the caregiver C such as a smartphone can be used to communicate the signal 210 to the receiver 202a.

In addition to the caregiver C, visitors such as family members and friends of the patient P can also each wear a tag 208 that wirelessly communicates a signal 210 to the receiver 202a. These visitors can also be users of the medical device 100.

The signal 210 transmitted by the tags 208 includes digital data such as an identification (ID) number that can be used to identify the user of the medical device 100. In some examples, the ID number included in the signal 210 is used to identify a role of the user such as whether the user is a physician, a registered nurse, a physician assistant, a respiratory therapist, a personal care assistant, a certified nurse aide, and the like, or whether the user does not have specialized medical training such as when the user is a visitor of the patient P.

The role of the user can have time variable, facility defined privileges. As will be described in more detail below, the user interfaces that are generated by the system 200 can block a control from being displayed or enable enhanced controls to be displayed based on the time variable, facility defined privileges. As a further example, a user can have certain privileges during their shift, and these privileges are terminated when the user is off shift such that the user interfaces generated by the system 200 are customizable based on the privileges of the user.

Additionally, the ID number included in the signal 210 can be used to identify whether the user has a disability such as colorblindness or other vision impairment that would affect their ability to effectively use the user interfaces displayed on the medical device 100. In some examples, the ID number for each user of the medical device 100 is stored in a look up table that associates the ID number with a role and/or disability of the user. The look up table can be stored in a memory of the system 200, or can be stored in a memory of the medical device 100. The look up table can be editable by the users of the medical device 100 such that they can enter color preferences, font, and other layout preferences allowed from a list of options. An example schema of an ID number stored in the look up table is provided Table 1 below.

TABLE 1

| ID Number | Role | Disability |
|---|---|---|
| XYZ123 | Respiratory | Tritanopia |
| | Therapist | Colorblindness |

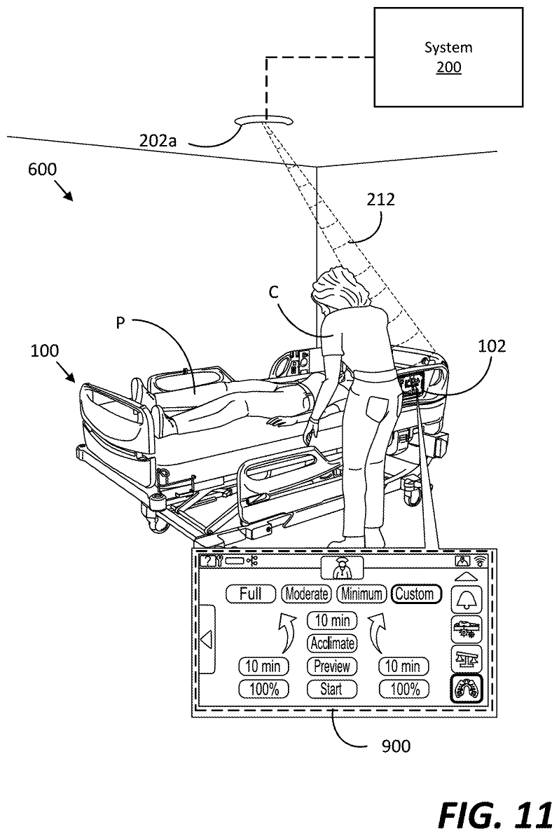

FIG. 11 illustrates an example of modifying the user interface displayed on the medical device 100 based on a role of the caregiver C. Before the caregiver Centers the first location 600 where the medical device 100 is located, the system 200 can use the receiver 202a to transmit the signal 212 to instruct the display device 102 to display the user interface 700 that has the simplified set of controls (see FIG. 6). After the caregiver C is detected as being in the first location 600 where the medical device 100 is located (see FIG. 10), the system 200 can use the receiver 202a to transmit the signal 212 which instructs the display device 102 to stop displaying the user interface 700, and to instead display another user interface that is optimal for the role of the caregiver C, as is shown in the example provided in FIG. 11.

In this illustrative example, when the system 200 identifies the caregiver C as a respiratory therapist based on the ID number included in the signal 210 communicated from the tag 208 worn by the caregiver C (see FIG. 10), the system 200 can send the signal 212 to instruct the display device 102 to display the user interface 900 which is optimal for use by a respiratory therapist. As described above, the user interface 900 includes the second set of controls 902 that are more complex than the first set of claims 702. For example, the second set of controls 902 can be selected by the caregiver C to perform CLRT, which is an option that is not available in the first set of controls 702 included in the user interface 700. Accordingly, the system 200 can control the display device 102 to optimize the user interfaces displayed on the medical device 100 based on the role of a user who is detected near the medical device 100.

In further examples, the user interface displayed on the medical device can block a user from changing, starting, or discontinuing certain parameters or treatments such as flow rates for infusion pumps, respirators, or other connected devices unless an authorized caregiver is detected near the medical device 100. In some further examples, the user interface additionally requires the authorized caregiver to enter a password or other identifier in order to allow changing, starting, or discontinuing the parameters or treatments of the medical device 100.

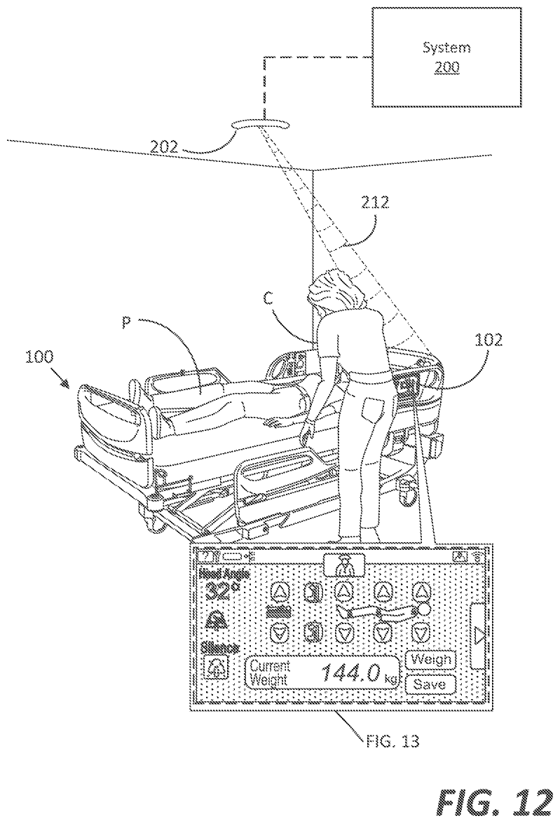

FIG. 12 illustrates another example of modifying the user interface displayed on the medical device 100 based on both a role and a disability of the user. As discussed above, the system 200 can identify the disability of the user based on the ID number included in the signal 210 communicated from the tag 208 worn by the user (see FIG. 10). In this example, the signal 212 instructs the display device 102 to stop displaying the user interface 700 (see FIG. 6), and to instead display a user interface 1300 that is optimized based on the role and disability of the user.

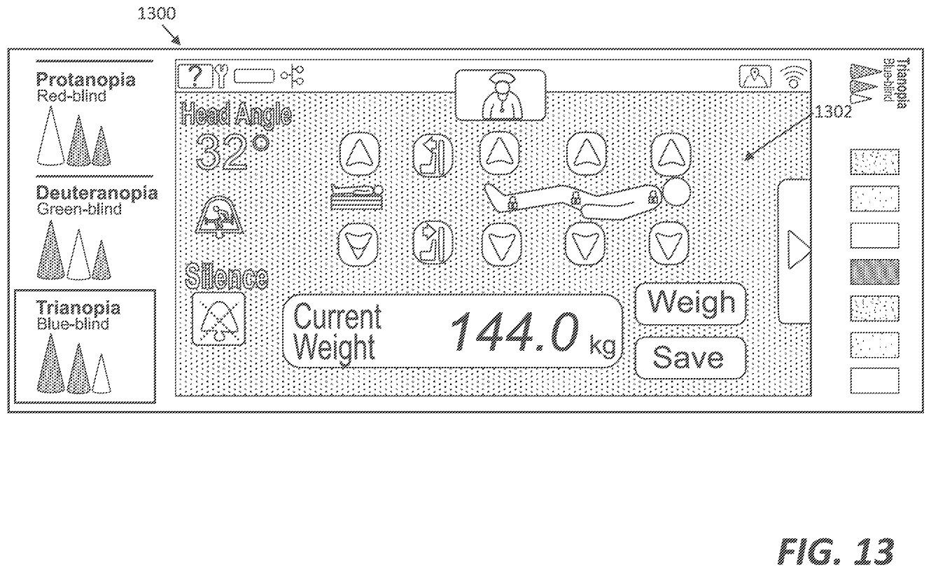

FIG. 13 illustrates the user interface 1300 in more detail. In this example, the system 200 identifies the user as a personal care assistant who has tritanopia colorblindness (i.e., inability to distinguish between blue and green colors). The user interface 1300 is optimized for use by personal care assistants based on the role of the caregiver C. For example, the user interface 1300 includes general bed operation controls 1302. In some examples, the user interface 1300 provides access to other controls if needed such as the first and second sets of controls 702, 902. Alternatively, the user interface 1300 is locked to only display the general bed operation controls 1302 such that a user is blocked from viewing and/or selecting other controls such as the first and second sets of controls 702, 902. Also, the user interface 1300 is optimized for use by users who have tritanopia colorblindness such as by displaying a specialized color scheme that is recognizable by users who have this visual impairment.

The user interface 1300 is an example of a user interface that has been modified based on the location of the medical device 102, a role of the user, and a disability of the user. For example, the location of the medical device 102 can be used to optimize the user interface 1300 in combination with the role and disability of the user of the medical device 102. Additionally, the user interface 1300 can block a control from being displayed on the display device 102 based on at least one of the location of the medical device 102, the role of the user, and the disability of the user.

The color scheme of the user interface can be modified based on the type of colorblindness of the user. For example, in addition to the color scheme for tritanopia colorblindness, other color schemes can be displayed on the display device 102 based on the visual impairment of the user such as color schemes that are optimized for protanopia colorblindness (i.e., inability to distinguish between red and green colors), deuteranopia colorblindness (i.e., inability to distinguish between red and green colors), and the like.

In some examples the disability of a user of the medical device 100 can include other types of vision impairments such as myopia (i.e., nearsightedness), hyperopia (i.e., farsightedness), astigmatism, presbyopia, age-related macular degeneration, cataracts, amblyopia, and the like. In such examples, the user interfaces generated on the medical device 100 can be optimized for viewing based on the user's vision impairment such as by displaying text in a larger font size or in a bolder font type. Additional examples are possible where the user interfaces can be optimized based on the disability of the user of the medical device 100.

In some examples, the receiver 202 can be installed on the medical device 100 such that the medical device 100 can identify the users who are near the device, and determine their associated roles and disabilities based on the signals 210 communicated from the tags 208 worn by the users. In such examples, the medical device 100 can automatically modify the user interfaces displayed on the display device 102 based on the role and disability of the users once the medical device 100 identifies the users who are near the medical device.

In examples where multiple users are each wearing a tag 208 and are in the same location relative to the medical device 100, the system 200 can utilize a hierarchy that prioritizes the users based on their roles. For example, the system 200 can recognize that both the caregiver C and a family member of the patient P are near the medical device 100 based on the signals 210 communicated from the tags 208 worn respectively by the caregiver C and the family member. In such instances, the system 200 can prioritize the caregiver C over the family member because the caregiver C is identified in the hierarchy as having a higher level of training for operating the medical device 100. Thus, the system 200 can optimize the user interface displayed on the medical device 100 based on the role or disability of the caregiver C instead of the family member when both persons are near the medical device 100.

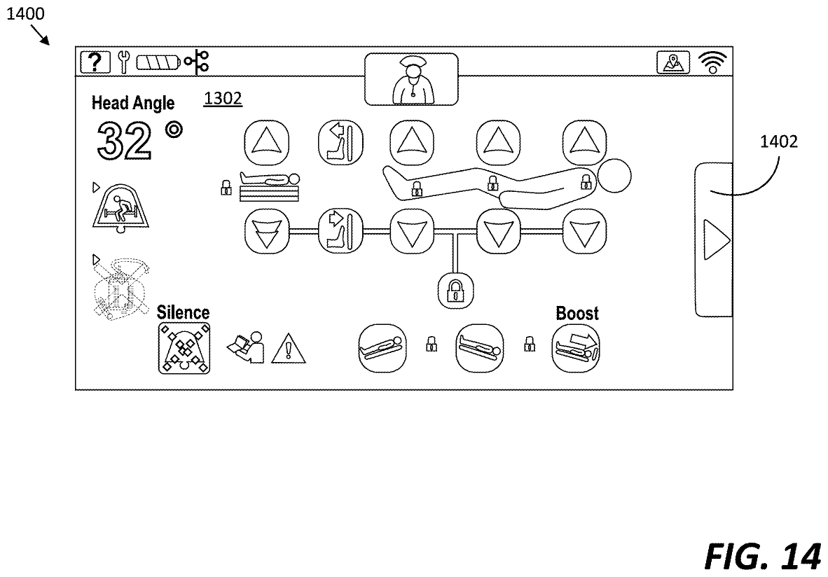

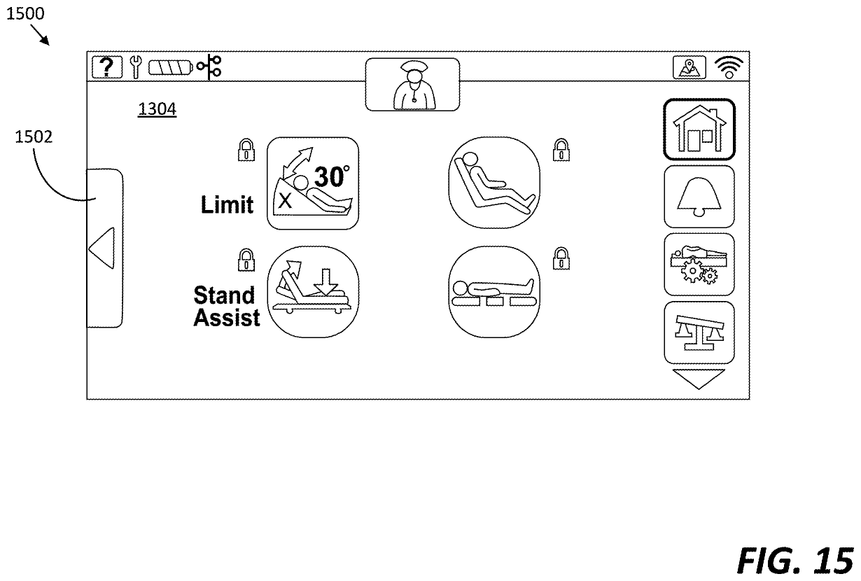

FIGS. 14 and 15 respectively show examples of general access screens 1400, 1500 that are optimized for registered nurses that can be displayed on the medical device 100. The general access screens 1400, 1500 can be toggled back and forth by swiping right and left on the display device 102, or by selecting the swipe button inputs 1402, 1502. The general access screens 1400, 1500 are automatically displayed on the medical device 100 when a registered nurse is detected near the medical device in accordance with the examples described above.

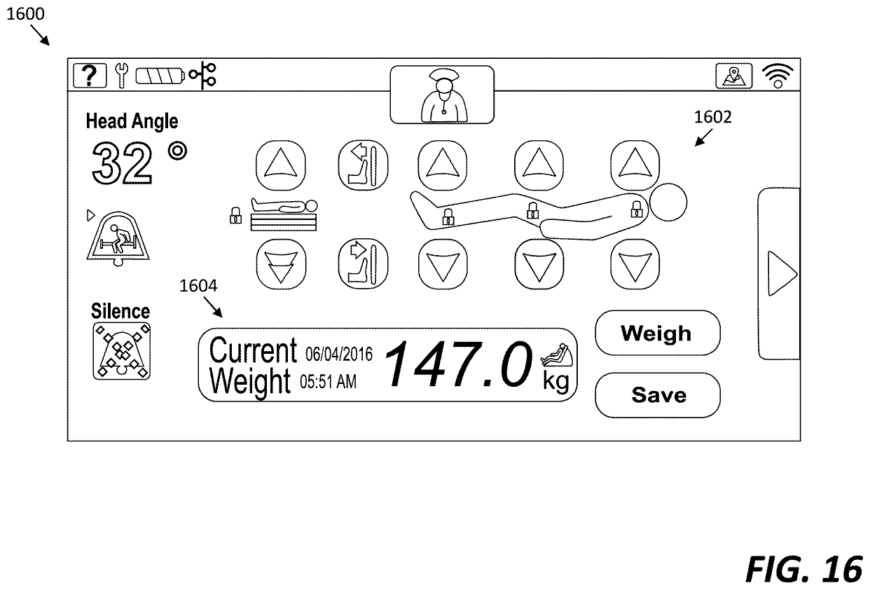

FIG. 16 shows an example of a user interface 1600 that is optimized for use by personal care assistants and certified nurse aides that can be displayed on the medical device 100. The user interface 1600 is similar to the user interface 1300 of FIG. 13 except that the user interface 1600 does not include the specialized color scheme for tritanopia colorblindness. The user interface 1600 is automatically displayed on the display device 102 whenever a personal care assistant or certified nurse aide is detected near the location of the medical device 100. Since these medical personnel typically measure patient weights, the user interface 1600 includes articulation controls 1602 and scale controls 1604 for operating the medical device 100.

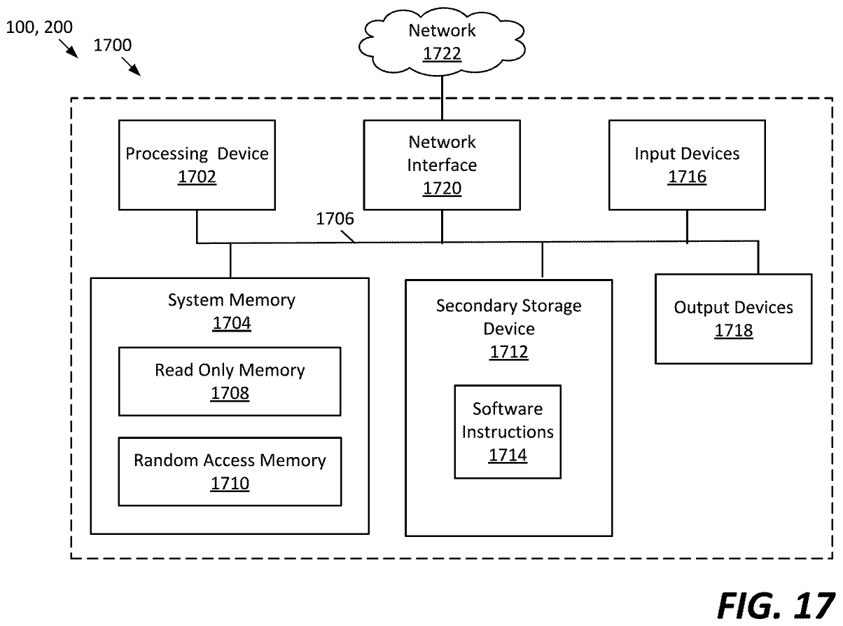

FIG. 17 illustrates an exemplary architecture of a computing device 1700 that can be used to implement aspects of the present disclosure, including aspects performed on the medical device 100 or by the system 200. The computing device 1700 can be used to execute an operating system, application programs, and software modules described herein.

The computing device 1700 includes at least one processing device 1702, such as a central processing unit (CPU). In this example, the computing device 1700 also includes a system memory 1704, and a system bus 1706 that couples various system components including the system memory 1704 to the at least one processing device 1702. The system bus 1706 is one of any number of types of bus structures including a memory bus, or memory controller, a peripheral bus, and a local bus using any of a variety of bus architectures.

The system memory 1704 includes read only memory (ROM) 1708 and random-access memory (RAM) 1710. A basic input/output system containing the basic routines that act to transfer information within computing device 1700, such as during start up, can be stored in the read only memory 1708. The random-access memory 1710 can be used to load and subsequently analyze data entered or otherwise collected by the medical device 100.

The computing device 1700 can also include one or more secondary storage devices 1712 connected to the system bus 1706. The secondary storage devices 1712 and their associated computer readable media provide nonvolatile storage of computer readable software instructions 1714 which can include application programs and program modules, data structures, and other data. Program modules can be stored in the secondary storage device 1712 or the system memory 1704, including an operating system, one or more application programs, other program modules (e.g., software engines described herein), and program data.

The computing device 1700 typically includes at least some form of computer readable media. Computer readable media includes any available media that can be accessed by the computing device 1700. By way of example, computer readable media include computer readable storage media and computer readable communication media.

Computer readable storage media includes volatile and nonvolatile, removable, and non-removable media implemented in any device configured to store information such as computer readable instructions, data structures, program modules or other data. Computer readable storage media includes, but is not limited to, random access memory, read only memory, electrically erasable programmable read only memory, flash memory, compact disc read only memory, digital versatile disks or other optical storage, magnetic cassettes, magnetic tape, magnetic disk storage or other magnetic storage devices, or any other medium that can be used to store the desired information and that can be accessed by the computing device. Computer readable storage media can include local storage or cloud-based storage.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device 1700 has one or more input devices 1716. Examples of input devices 1716 include a touch sensor such as a touchpad or touch sensitive display or touchscreen, and can also include one or more buttons that can be physically pressed. The input devices 1716 are connected to the at least one processing device 1702 through the system bus 1706.

The computing device 1700 includes one or more output devices 1718. The output devices 1718 are connected to the system bus 1706. The display device 102 is a touchscreen such that it is both an input device 1716 and an output device 1718. In addition to the display device 102, the computing device 1700 can include additional types of output devices such as speakers.

The computing device 1700 can connect to a network 1722 such as a local area network through a network interface 1720, such as an Ethernet interface. In other examples, different communication devices can be used. For example, the computing device 1700 can also include a wireless router for communicating wirelessly across the network 1722.

The computing device 1700 is also an example of programmable electronics, which may include one or more such computing devices, and when multiple computing devices are included, such computing devices can be coupled together with a suitable data communication network to collectively perform the various functions, methods, or operations disclosed herein.

Although specific embodiments are described herein, the scope of the disclosure is not limited to those specific embodiments. The scope of the disclosure is defined by the following claims and any equivalents thereof.

What is claimed is:

1. A system for operating a medical device, the system comprising:
at least one processing device; and
a memory device storing instructions which, when executed by the at least one processing device, cause the at least one processing device to:
monitor an environment of the medical device;
detect a change in the environment including at least one of a change in a location of the medical device and a presence of a user near the medical device; and
modify a user interface displayed on the medical device in response to the change in the environment, the user interface being modified based on the location of the medical device, a role of the user, and a disability of the user.

2. The system of claim 1, wherein the instructions, when executed by the at least one processing device, further cause the at least one processing device to:
detect a plurality of users near the medical device;
prioritize a single user over other users in the plurality of user based on the role of the single user having a higher priority than the roles of the other users; and
modify the user interface based on the role of the single user.

3. The system of claim 1, wherein the instructions, when executed by the at least one processing device, further cause the at least one processing device to:
record an input received from the user interface after detection of the change in the environment of the medical device.

4. The system of claim 3, wherein the instructions, when executed by the at least one processing device, further cause the at least one processing device to:
record at least one of a location, a time, and a user ID number associated with the input received from the user interface.

5. The system of claim 1, wherein the disability of the user is colorblindness, and the user interface is modified to include a color scheme based on the colorblindness.

6. The system of claim 1, wherein the disability of the user is vision impairment, and the user interface is modified to include text having a font based on the vision impairment.

7. The system of claim 1, wherein the instructions, when executed by the at least one processing device, further cause the at least one processing device to:
block a control from being displayed on the user interface based on at least one of the location of the medical device, the role of the user, and the disability of the user.

8. A method of operating a medical device, the method comprising:
monitoring an environment of the medical device;
detecting a change in the environment including at least one of a change in a location of the medical device and a presence of a user near the medical device; and
modifying a user interface displayed on the medical device in response to the change in the environment, the user interface being modified based on the location of the medical device, a role of the user, and a disability of the user.

9. The method of claim 8, further comprising:
detecting a plurality of users near the medical device;
prioritizing a single user over other users in the plurality of user based on the role of the single user having a higher priority than the roles of the other users; and
modifying the user interface based on the role of the single user.

10. The method of claim 8, further comprising:
recording an input received from the user interface after detection of the change in the environment of the medical device.

11. The method of claim 10, further comprising:
recording at least one of a location, a time, and a user ID number associated with the input received from the user interface.

12. The method of claim 8, wherein the disability of the user is colorblindness, and the user interface is modified to include a color scheme based on the colorblindness.

13. The method of claim 8, wherein the disability of the user is vision impairment, and the user interface is modified to include text having a font based on the vision impairment.

14. The method of claim 8, further comprising:
blocking a control from being displayed on the user interface based on at least one of the location of the medical device, the role of the user, and the disability of the user.

15. The method of claim 8, further comprising:
communicating with other medical devices in the location of the medical device; and
enabling control functions on the other medical devices in response to the change in the environment of the medical device.

16. A non-transitory computer-readable data storage medium comprising instructions that, when executed, cause at least one computing device to:
monitor an environment of the medical device;
detect a change in the environment including at least one of a change in a location of the medical device and a presence of a user near the medical device; and
modify a user interface displayed on the medical device in response to the change in the environment, the user interface being modified based on the location of the medical device, a role of the user, and a disability of the user.

17. The non-transitory computer-readable data storage medium of claim 16, wherein the instructions, when executed, further cause the at least one computing device to:
detect a plurality of users near the medical device;
prioritize a single user over other users in the plurality of user based on the role of the single user having a higher priority than the roles of the other users; and
modify the user interface based on the role of the single user.

18. The non-transitory computer-readable data storage medium of claim 16, wherein the instructions, when executed, further cause the at least one computing device to:
record an input received from the user interface after detection of the change in the environment of the medical device.

19. The non-transitory computer-readable data storage medium of claim 18, wherein the instructions, when executed, further cause the at least one computing device to:
record at least one of a location, a time, and a user ID number associated with the input received from the user interface.

20. The non-transitory computer-readable data storage medium of claim 16, wherein the instructions, when executed, further cause the at least one computing device to:
block a control from being displayed on the user interface based on at least one of the location of the medical device, the role of the user, and the disability of the user.
